(19) United States
(12) Patent Application Publication
(10) Pub. No.: US 2026/0212776 A1
(43) Pub. Date: Jul. 23, 2026

(54) PROCTORING OF ONLINE EXAMINATIONS USING GAZE DETERMINATION

(71) Applicants: Constructor Technology AG, Schaffhausen (CH); Constructor Education and Research Genossenschaft, Schaffhausen (CH)

(72) Inventors: Karsten KOZEMPEL, Nürnberg (DE); Nwafor Chinedu KENNETH, Singapore (SG); Andrey ADASHCHIK, Istanbul (TR); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/034,694

(22) Filed: Jan. 23, 2025

(51) Int. Cl. G09B 7/00; G06T 7/73

(52) U.S. Cl. CPC G09B 7/00; G06T 7/73; G06T 2207/20081; G06T 2207/20084; G06T 2207/30201

(57) ABSTRACT

Disclosed herein are systems and methods for proctoring online examinations by determining a gaze of a user. The method includes: performing a calibration process to calibrate a field of view of a user taking an online examination on a computer; after the calibration process is completed, obtaining a gaze origin and a gaze vector of the user using a prepared neural network to obtain facial key points of the user and determining, by a webcam or camera, the gaze of the user in three-dimensional (3D) coordinates to determine whether the gaze vector of the user is within a defined boundary relative to the gaze origin; and based on a determination that the gaze vector of the user is outside the defined boundary for a period of time, transmitting a message that the gaze of the user is outside of the defined boundary.

### FIELD OF TECHNOLOGY

The present disclosure relates to the field of machine learning, and, more specifically, to systems and methods for machine-learning based methods for proctoring online examinations.

### BACKGROUND

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner's login credentials. In other cases, in examinations with video proctoring, a pre-recorded video loop of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. To counteract these tactics, some online examination platforms are increasingly using sophisticated Al proctoring techniques.

### SUMMARY

To address the shortcoming of proctoring online examinations, the present disclosure describes training neural networks to detect the gaze of a user taking an online examination on a computer. Detecting the gaze of a user taking an online examination on a computer offers several technical benefits that enhance the security, usability, and effectiveness of the online examination environment. A first technical benefit is automated alerts for cheating detection such that gaze detection can flag or identify suspicious behavior in real-time such as looking away from the screen frequently or focusing on off-screen areas where unauthorized materials may be present. Another technical benefit is collecting gaze data to determine how much learners spend reading or interacting with specific questions to provide instructors with feedback on the examination questions. Yet another technical benefit is reducing false positives by differentiating between natural eye movements and suspicious activity to reduce the likelihood of penalizing users for innocent behavior (e.g., glancing to think). By leveraging gaze detection, online examination systems can provide a more secure, fair, and efficient testing environment while gathering valuable insights to improve the overall exam-taking experience.

In one exemplary aspect, a method for proctoring online examinations is disclosed. The method including: performing a calibration process to calibrate a field of view of a user taking an online examination on a computer; after the calibration process is completed, obtaining facial key points of the user for determining a gaze origin and a gaze vector of the user using a prepared neural network and determining, by a webcam or camera, a gaze of the user in three-dimensional (3D) coordinates to determine whether the gaze vector of the user is within a defined boundary relative to the gaze origin; and based on a determination that the gaze vector of the user is outside the defined boundary for a period of time, transmitting a message that the gaze of the user is outside of the defined boundary.

In one aspect, performing the calibration process further includes: displaying a first number in a single point of a display when the user is in a first position, wherein the single point is a predefined distance away from a virtual border along a y axis or a x axis and the virtual border is generated at a predefined angle from the y axis or the x axis such that the virtual border demarcates the display into an allowed zone and a forbidden zone; based on a determination that the user has correctly identified the first number on the display, obtaining a first image of the user gazing at the single point of the display when the user is in the first position; displaying a second number in the single point of the display when the user is in a second position; based on a determination that the user has correctly identified the second number on the display, obtaining a second image of the user gazing at the single point of the display when the user is in the second position, wherein the defined boundary for the user is further defined using the forbidden zone based on the virtual border and by obtaining 3D vector coordinates for the gaze of the user by using triangulation or parallax and the first image and the second image.

In one aspect, the second position is shifted laterally along an axis with respect to the first position.

In one aspect, performing the calibration process further includes: displaying a first number in a first point of a display when the user is in a first position, wherein the first point is along a first boundary of a display; based on a determination that the user has correctly identified the first number on the display, obtaining a first image of the user gazing at the first point of the display when the user is in the first position; displaying a second number in a second point of the display when the user is in the first position; based on a determination that the user has correctly identified the second number on the display, obtaining a second image of the user gazing at the second point of the display when the user is in the first position; displaying a third number in a first point of the display when the user is in a second position; based on a determination that the user has correctly identified the third number on the display, obtaining a third image of the user gazing at the first point of the display when the user is in the second position; displaying a fourth number in the second point of the display when the user is in the second position; based on a determination that the user has correctly identified the fourth number on the display, obtaining a fourth image of the user gazing the second point of the display when the user is in the second position, wherein the defined boundary for the user is defined by obtaining 3D vector coordinates for each gaze of the user in the first position and the second position by using triangulation or parallax and the first, second, third, and fourth images.

In one aspect, the second position is shifted laterally along an axis with respect to the first position.

In one aspect, wherein performing the calibration process further includes: when the user is in a first position, display a first number, a second number, a third number, a fourth number in a first corner, a second corner, a third corner, and a fourth corner of a display, respectively; based on a determination that the user has correctly identified the first number, the second number, the third number, and the fourth number on the display, obtaining a respective image of the user gazing at each of the first corner, the second corner, the third corner, and the fourth corner of the display when the user is in the first position; when the user is in a second position, display a fifth number, a sixth number, a seventh number, an eighth number in the first corner, the second corner, the third corner, and the fourth corner of a display, respectively; based on a determination that the user has correctly identified the fifth number, the sixth number, the seventh number, and the eighth number on the display, obtaining a respective image of the user gazing at each of the first corner, the second corner, the third corner, and the fourth corner of the display when the user is in the second position, wherein the defined boundary is defined for the user by obtaining 3D origin and vector coordinates for each gaze of the user in the first position and the second position by using triangulation or parallax and the obtained images of the user gazing at each of the first corner, the second corner, the third corner, and the fourth corner when the user is in the first position and the second position.

In one aspect, the second position is shifted laterally along an axis with respect to the first position.

In one aspect, the prepared neural network corresponds to at least one of: a gaze estimator, and a neural network that detects 3D facial key points and returns a 3D origin and vector of the gaze.

In one aspect, the method further includes: preparing the neural network to determine whether the gaze of the user is within the defined boundary by training the neural network to detect the gaze of the user using a training dataset comprising of facial images of people gazing in different directions and a corresponding gaze origin and direction label for each image.

In one aspect, the method further includes: preparing of the neural network to determine whether the gaze of the user is within the defined boundary by training the neural network to detect the gaze of the user using a training dataset comprising of images of facial keypoints comprising at least eyeballs, iris, or pupils to compute a gaze origin and vector in a post-processing step.

In one aspect, detecting the gaze of the user in 3D coordinates to determine whether the gaze vector of the user is within a defined boundary relative to the gaze origin further includes computing the gaze vector in a post-processing step.

According to one aspect of the disclosure, a system is provided for proctoring online examinations, the system comprising at least one memory; and at least one hardware processor coupled with the at least one memory and configured, individually or in combination to: perform a calibration process to calibrate a field of view of a user taking an online examination on a computer; after the calibration process is completed, obtain facial key points of the user for determining a gaze origin and a gaze vector of the user using a prepared neural network to obtain facial key points of the user and determining, by a webcam or camera, a gaze of the user in three-dimensional (3D) coordinates to determine whether the gaze vector of the user is within a defined boundary relative to the gaze origin; and based on a determination that the gaze vector of the user is outside the defined boundary for a period of time, transmit a message that the gaze of the user is outside of the defined boundary.

In one exemplary aspect, a non-transitory computer-readable medium is provided storing a set of instructions thereon proctoring online examinations, wherein the set of instructions comprises instructions for: performing a calibration process to calibrate a field of view of a user taking an online examination on a computer; after the calibration process is completed, obtain facial key points of the user for determining a gaze origin and a gaze vector of the user using a prepared neural network to obtain facial key points of the user and determining, by a webcam or camera, a gaze of the user in three-dimensional (3D) coordinates to determine whether the gaze vector of the user is within a defined boundary relative to the gaze origin; and based on a determination that the gaze vector of the user is outside the defined boundary for a period of time, transmitting a message that the gaze of the user is outside of the defined boundary.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for an artificial intelligence (AI)-based method for proctoring online examinations according to aspects of the present disclosure.

FIG. 2 is a diagram illustrating an approach of training a machine learning model (MLM) to perform proctoring online examinations according to aspects of the present disclosure.

FIGS. 3A-I is an example process flow of performing a calibration process to calibrate a field of view of a user according to aspects of the present disclosure.

FIGS. 4A-D is an example process flow of performing a gaze determination method for the user taking the online examination according to aspects of the present disclosure.

FIGS. 5A-5F is an example process flow of performing a calibration process to calibrate a field of a user using a single point based on a virtual border according to aspects of the present disclosure.

FIG. 6 is a flow diagram of a method performing a gaze determination method according to aspects of the present disclosure.

FIG. 7 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for a machine-learning (ML)-based method for proctoring online examinations by determining a gaze of a user taking a test. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of determining a gaze of a user to determine whether the gaze of a user is within a gaze boundary for a period of time. One aspects involves performing a calibration process to calibrate a field of view of a user taking an online examination. A second aspect involves training a neural network to determine whether the gaze of the user is within a defined boundary. A third aspect involves utilizing the neural network to obtain facial key points of the user for obtaining a gaze origin and a gaze vector of the user. A fourth aspect involves detecting, by a webcam, a gaze of the user while the user is taking an online examination to determine whether the gaze of the user is outside a gaze boundary for a period of time.

Consider that users may naturally move their heads while thinking, reading, or adjusting their posture. Blinking, squinting, or looking away momentarily to think can also resemble suspicious behavior. These movements and actions can disrupt gaze detection algorithms and require additional stabilization algorithms. In addition, there are environmental challenges such as poor lighting, shadows, or backlighting that can obscure facial features and make it difficult to accurately detect a gaze. Variability in user gaze due to non-suspicious reasons (e.g., natural head movements) generates “noisy” data, making it hard to draw reliable conclusions. Furthermore, users take examinations on a variety of devices (laptops, desktops, etc.) each with different camera capabilities and specifications, making it difficult to standardize gaze detecting.

The present disclosure describes using advanced Machine Learning Models (MLM) to improve gaze detection accuracy, even in suboptimal conditions. A calibration process may be employed to calibrate a field of view of the user during an online examination such that an adaptive system is tailored to individual users and their examination taking environments. For example, neural networks may be configured to detect a user's gaze by analyzing key facial features, including at least eyeballs, iris, or pupil, to compute a gaze origin and vector during post-processing steps. These neural networks facilitate the continuous detection of a user's gaze vector. Furthermore, by monitoring the user's gaze vector, the system can provide valuable feedback on examination questions, such as identifying which parts of the screen captures the most attention. This data offers insights into user behavior, including indicators of stress or difficulty.

Turning now to the figures, example aspects are depicted with reference to one or more components described herein, where components in dashed lines may be optional.

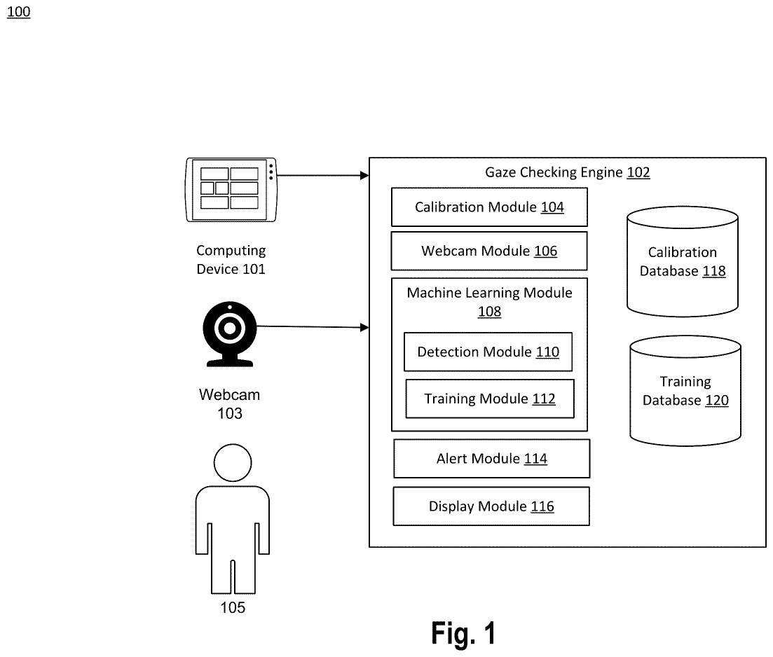

FIG. 1 is a block diagram illustrating a system 100 for a method of proctoring online examinations. The system 100 may be used to perform a calibration process to calibrate a field of view of a user 105 taking an online examination on a computing device 101 and detect a gaze of the user 105 in three-dimensional (3-D) coordinates using a prepared neural network using a webcam 103 or camera. The computing device 101 and/or webcam 103 may communicate with a gaze checking module 102.

As shown in system 100, during an online examination, the webcam 103 may be coupled directly to the computing device 101 or coupled to the gaze checking module 102 to detect the gaze of the user 105 taking the online examination on the computing device 101. In some aspects, a camera may be set up in the room that the user 105 is taking the online examination on the computing device 101 and coupled directly to the computing device 101 or the gaze checking module 102. The webcam 103 and/or camera are effectively utilized to obtain a gaze origin and gaze vector of the user 105 and to optionally determine gaze by leveraging advanced computer vision and MLM techniques. These systems analyze facial features, particularly the position and movement of the eyes, to determine where the user 105 is looking in real-time.

The system 100 may also include the computing device 101 and the gaze checking module 102. The computing device 101 allows a user to take an online examination administered and proctored by the system 100. The computing device 101 may execute a plurality of modules in the gaze checking module 102 that together make up a calibration, analysis, determining, and alert system. In some aspects, the gaze checking module 102 may correspond to the computing device 101 or a cloud network (not shown) that is configured to execute a plurality of modules that together make up the gaze checking module 102. The gaze checking module 102 may obtain video streams from the webcam 103 capturing the user 105 taking the online examination on the computing device 101.

In some aspects, the gaze checking module 102 may include a calibration module 104, a webcam module 106, a machine learning module 108 including a detection module 110 and a training module 112, an alert module 114, a display module 116, a calibration database 118 and a training database 120.

The computing device 101 may execute a calibration module 104 that is configured to ensure that the field of view (FOV) for monitoring the user 105 is appropriately set up. The calibration process is critical to validate the integrity of the exam-taking environment for each user 105. Specifically, the calibration module 104 may be configured to perform a calibration process to calibrate a FOV of the user 105 taking an online examination on the computing device 101.

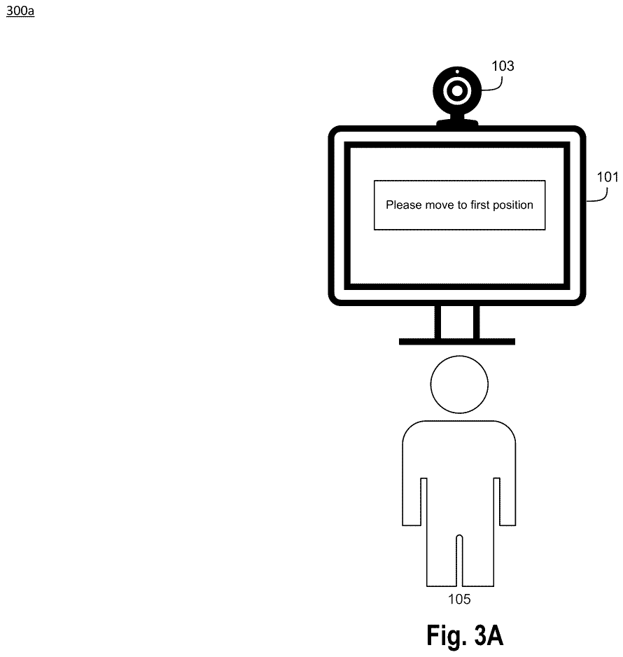

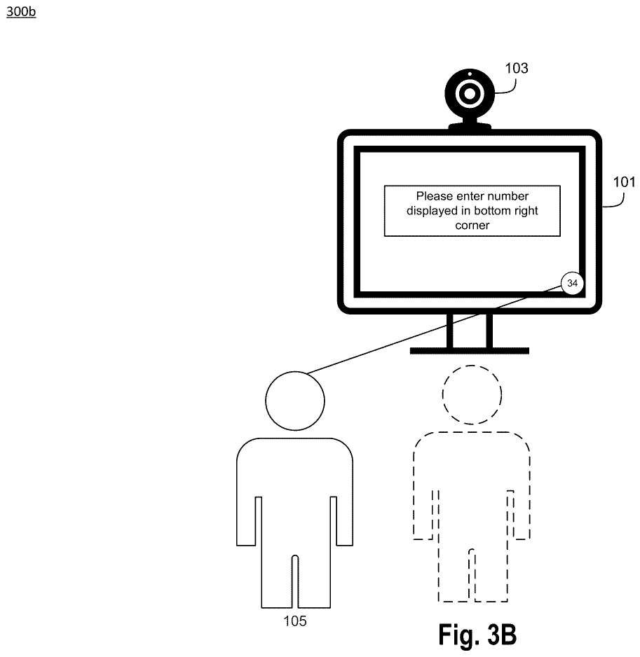

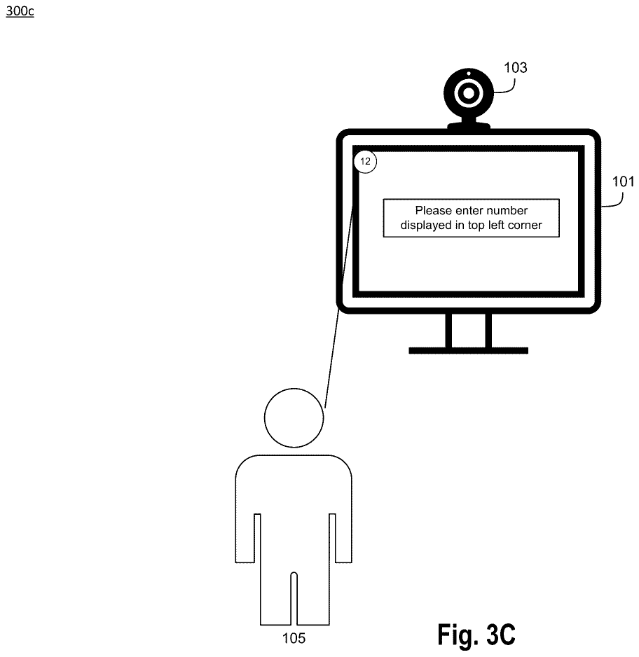

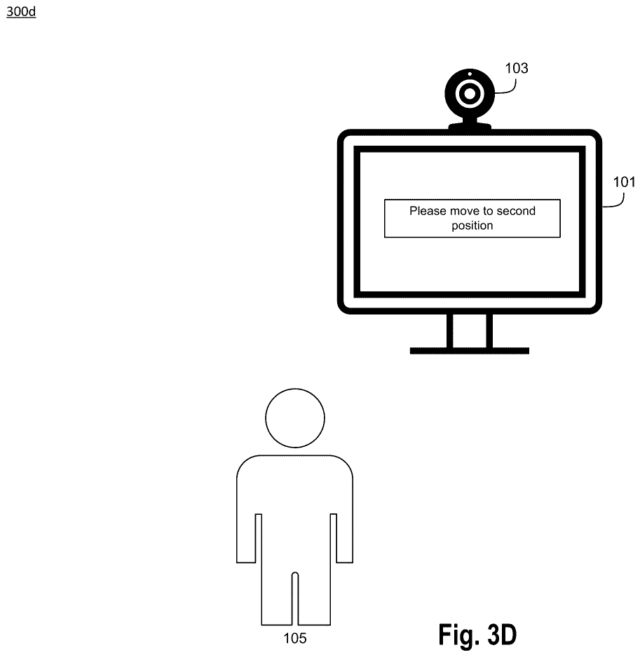

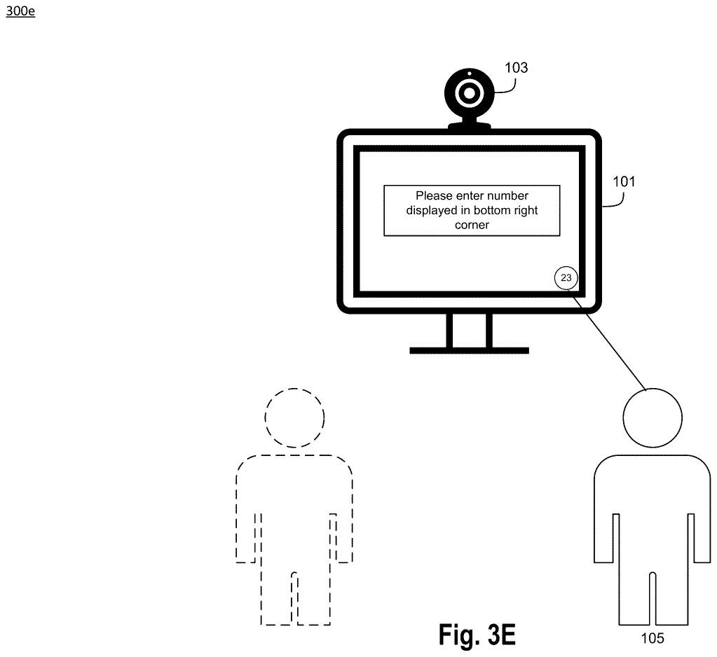

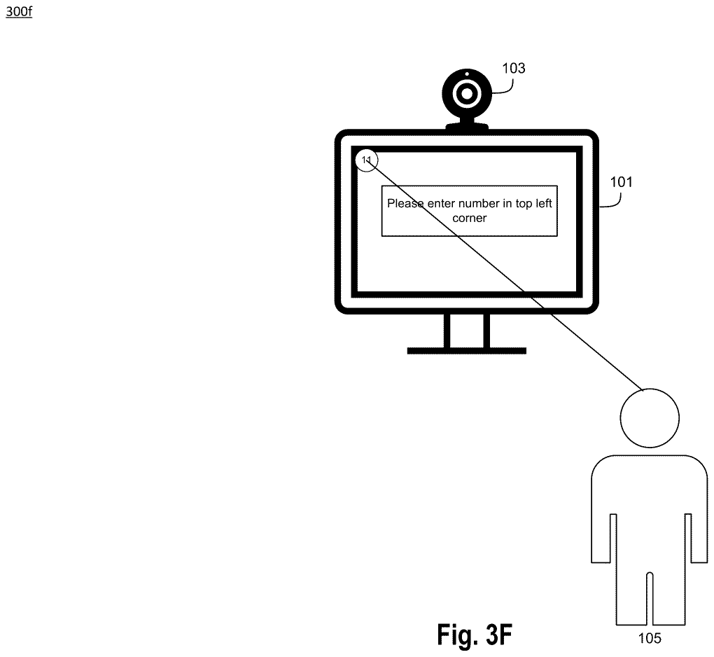

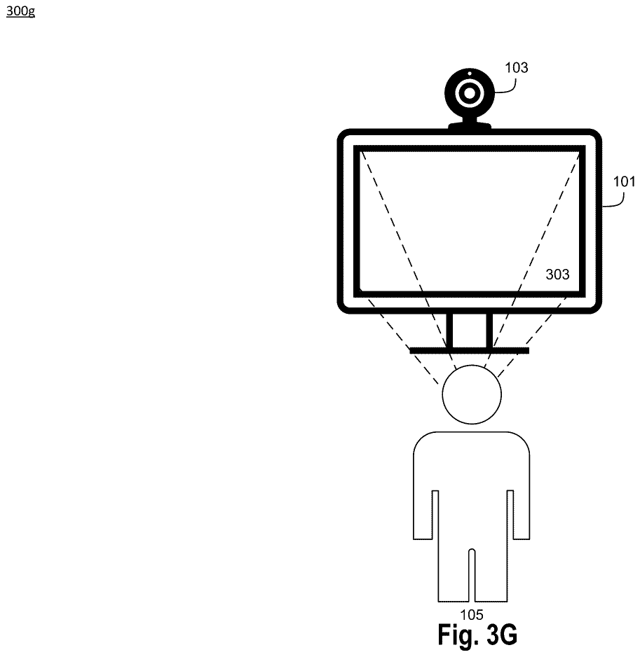

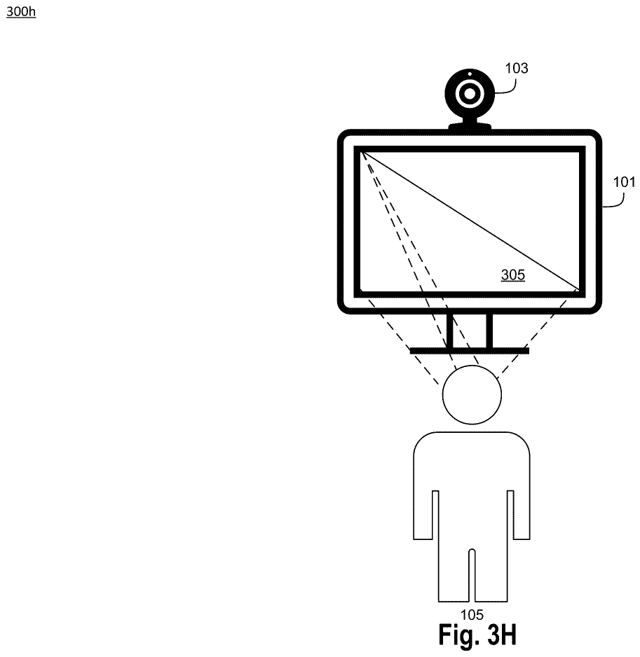

In some aspects, the calibration module 104 may be configured to display a number on at least one point of a display of the computing device 101 such that the user 105 will be required the input the displayed number at a first position and a second position to confirm that the user 105 is looking at each of the at least one point of the display. In this way, the calibration module 104 may obtain vector coordinates for each gaze in order to determine a defined boundary for the user 105. More detail about the calibration process will be discussed in FIGS. 3A-3G.

In some aspects, the calibration module 104 and/or the webcam module 106 may detect and connect to the webcam 103 or other cameras of the user 105. In some aspects, the calibration module 104 is configured to ensure the webcam 103 captures the scene with adequate lighting to detect facial features and the surrounding environment and prompt the user to adjust the camera lighting or camera angle if the FOV if unclear. In some aspects, the calibration module 104 is configured to ensure that the webcam 103 remains stable and is focused on the user 105 during calibration. In some aspects, the calibration module 104 is configured to provide clear instructions for any adjustments needed (e.g., move closer, adjust the webcam).

After calibration, the calibration module 104 may ensure that the user 105 is correctly framed in the camera's FOV, the surrounding environment is sufficiently monitored for unauthorized behavior (e.g., user gazing outside of the defined boundary), and the system 100 is ready to flag anomalies or violations during the exam. Calibration data for each user 105 may be stored in the calibration database 118.

The computing device 101 may execute a webcam module 106 that is configured to initialize and activate the webcam 103, verify that the webcam 103 is functioning correctly and is compatible with the system 100, and/or ensure that the correct camera is selected if multiple cameras are available (e.g., built-in webcams, external webcams, or other cameras). In some aspects, the webcam module 106 is configured to capture real-time video frames of the user (e.g., the face of the user) such that high-resolution images of the key points (facial, eyeballs, iris, or pupils) of the user may be extracted for gaze determination by the detection module 110.

The computing device 101 may execute a machine learning module 108 including the detection module 110 (which contains at least one specific prepared neural network) and a training module 112. In some aspects, the detection module 110 may include a prepared neural network configured to ensure the attention of the user 105 is directed at the screen during online examinations, detect cheating behaviors like looking away from the screen (e.g., looking at another test taker's screen or consulting unauthorized materials), and/or enhancing usability by accommodating natural head and eye movements while maintaining detection accuracy.

A neural network is a type of machine learning process that uses interconnected nodes or neurons in a layered structure that resembles the human brain. The neural networks create an adaptive system that computers use to learn from their mistakes and improve continuously by comprehending unstructured data and make observations without explicit training. With neural networks, computers may distinguish and recognize images similar to humans. However, the neural network in the detection module 110 must first go through training to teach the neural networks to perform their respective specific tasks.

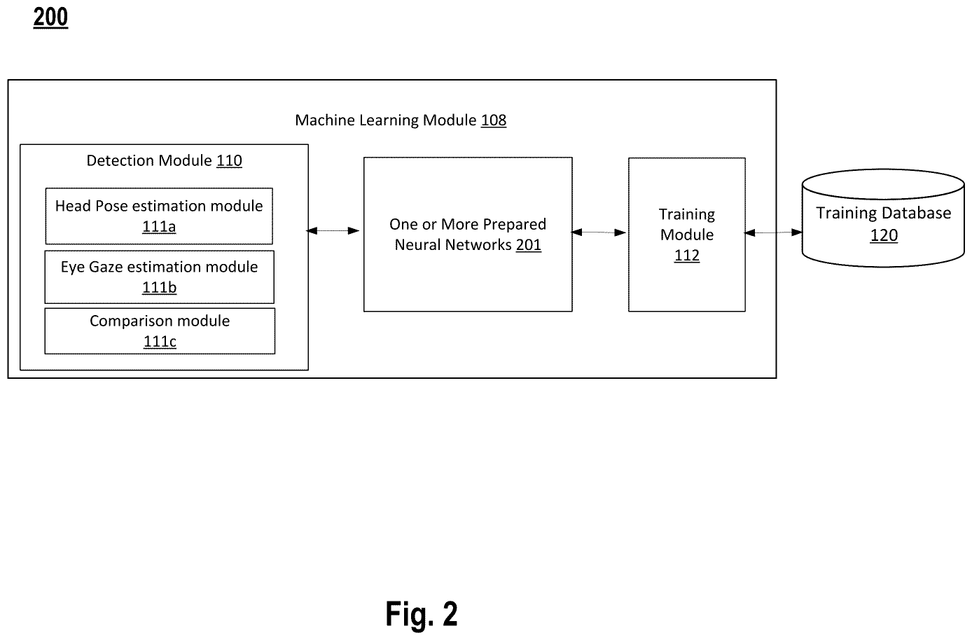

The machine learning module 108 may comprise one or more neural networks (e.g., the head pose estimation module 111a or the eye gaze estimation module 111b from FIG. 2), which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 108 may be one of the following: transformer neural network, convolution neural network (CNN), recurrent neural network (RNN), long short-term memory (LSTM) network, gated recurrent unit (GRU) network.

The trained neural network in the detection module 110 may also provide 3D estimation by extracting key features (e.g., facial key points) from a face of the user 105. The trained neural network may also integrate 2D visual data with head position and depth information to reconstruct 3D gaze direction. In some aspects, the trained neural network may assist in learning patterns by training on diverse datasets, the neural network generalizes to handle various users, lighting conditions, and head poses.

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

A CNN is specialized for processing grid-like data, such as images, and employs convolutional layers to learn spatial hierarchies of features, reducing the need for manual feature engineering. CNNs are well-suited for tasks like image classification, object detection, and image generation.

For image classification tasks such as gaze detection, the training module 112 will be configured to prepare an untrained neural network in the detection module 110 to obtain a gaze origin and a gaze vector of the user 105 and, optionally, to detect the gaze of the user 105 using a training dataset including facial images of people gazing in different directions and a corresponding gaze origin and direction label for each image. In some aspects, the training module 112 will train the untrained neural network in the detection module 110 on facial key points (e.g., facial, eyeballs, iris, or pupil) to obtain a gaze origin and gaze vector of the user 105. Accordingly, the training module 112 will be configured to prepare an untrained neural network in the detection module 110 to obtain a gaze origin and gaze vector of the user using a training dataset including images of facial components comprising at least eyeballs, iris, or pupils to compute a gaze origin and vector in a post-processing step.

During training, by the training module 112, of the neural network in the detection module 110 to obtain a gaze origin and gaze vector of the user 105 for defining a gaze boundary, the training dataset comprises training dataset comprising of facial images of people gazing in different directions and a corresponding gaze origin and direction label for each image that are input through an untrained neural network in the detection module 110. The results from the untrained neural network are then compared with known data set results using the corresponding labels identifying whether the gaze of the user 105 is within a defined boundary or outside a defined boundary. It should be noted that the input to the detection module 110 will only be the data from the training dataset. In some aspects, the training dataset may be obtained and stored on the training database 120.

For every input training sample from the training dataset, the neural network from the detection module 110 will produce a prediction consisting of values representing the probability that input image corresponds to a given class (e.g., gaze is within a defined boundary, or gaze is outside of the defined boundary). The output with the highest probability determines the predicted gaze boundary label. A class label for each input image is used to compute a loss (e.g., loss function).

The detection module 110 then uses a loss function that quantifies the error between the predicted output and the ground truth (e.g., position label) for a given training sample. In other words, the loss function can be used to guide the learning process by updating the network weights in a way that improves the accuracy of future predictions. This process may continue until the difference between the prediction and the correct targets is minimal.

Once a neural network is trained (e.g., inference), the detection module 110 may identify whether a gaze of the user 105 is inside or outside of the gaze boundary within the images from the webcam 103. In some aspects, the detection module 110 may identify whether a gaze of the user 105 is inside or outside of the gaze boundary within the images from the webcam 103 analytically. In some aspects, the detection module 110 contains a prepared neural network configured to detecting, by the webcam 103 or camera, a gaze of the user 105 in 3D coordinates using a prepared neural network to determine whether the gaze origin and vector of the user is within a defined boundary or outside the gaze boundary for a period of time in a plurality of images. As such, the detection module 110 is trained to detect the gaze of the user 105 in 3D coordinates based at least in part on identifying a gaze origin (e.g., the user's eye position) and the gaze vector (e.g., the direction of the gaze) in 3D space.

First, the trained neural network in the detection module 110 may preprocess the video frames to detect facial key points using a facial recognition algorithm, extract regions of interest (ROIs) around the eyes for detailed analysis, and normalize the input (e.g., resizing or adjusting brightness) to ensure consistent quality.

Second, the trained neural network in the detection module 110 may detect the gaze origin by identifying the 3D coordinates of the face of the user 105. As an example, facial key points help establish the relative position of the at least the eyes, nose, and head in the 3D coordinate system. In addition, depth estimation techniques (e.g., often using stereo vision or inferred from facial landmarks) may calculate the precise 3D location of each eye.

Third, the trained neural network in the detection module 110 may predict the gaze vector, which represents the direction the user 105 is looking. Eye images may be analyzed to detect pupil position, iris orientation, and scleral shape. Head pose estimation (e.g., using facial landmarks or 3D face models) may help refine the direction by accounting for head movement. The gaze vector is calculated as a 3D unit vector originating from the gaze origin and pointing in the direction of the line of sight of the user 105.

Fourth, the trained neural network in the detection module 110 may use CNNs for image analysis and feature extraction from the eyes and face (e.g., pupil position, scleral visibility). The trained neural network in the detection module 110 may extract features from the images and identify patterns that correspond to wither the user's gaze origin and vector fall within a defined boundary or outside a defined boundary. In some aspects, recurrent neural networks (RNNs) or similar architectures may refine predictions by analyzing temporal (time-based) changes in gaze over multiple frames.

Fifth, the gaze origin and vector are compared against a defined 3D boundary. The boundary may be defined as a polygon or a polygon in 3D coordinates where the user is expected to focus (e.g., the screen area of a computer). The system 100 may calculate whether the gaze vector intersects the boundary volume. In some aspects, an intersection test may compute whether the gaze vector crosses or remains within the defined 3D polygon. If the gaze vector remains outside this boundary for a specified time period, then the alert module will trigger an alert or flag.

During inference, the trained neural network from the detection module 110 does not re-evaluate or adjust the layers of the neural network based on the results. Instead, the inference applies knowledge from the trained neural network and uses it to infer a result. Accordingly, when a new unknown dataset is input through the trained neural network in the detection module 110, the trained neural network outputs a prediction of whether the user's gaze is within or outside of a defined boundary based on predictive accuracy of the neural network.

By combining camera input from the webcam 103, neural network processing, and 3D spatial calculations, the detection module 110 may provide robust and real-time gaze detection to ensure integrity in online examinations.

The computing device 101 may execute an alert module 114 that is configured to transmit a warning message that the gaze of the user is outside of the gaze boundary based on a determination that the gaze of the user is outside the gaze boundary for a period of time by the prepared neural network in the detection module 110.

The computing device 101 may execute a display module 116 configured to generate and display the online examination for administration to the user 105 and, in some aspects, the warning message that the gaze of the user is outside of the gaze boundary. Generally, the display module is responsible for managing and rendering the visual components of a user interface (UI) by handling the presentation of information to the user, ensuring that data and controls are displayed correctly and consistently across the UI.

In some aspects, the display module 116 is configured to render or draw all the elements of the UI, such as windows, buttons, text fields, menus, icons, images, and other components. In some aspects, the display module 116 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 116 may be considered the “view” part of a model-view-controller (MVC) or similar design pattern. It serves as the layer that presents data to the user and receives input to and from the computing device 101.

It should be noted that the prediction of whether a gaze of the user is within a defined boundary or whether the gaze of the user 105 is outside the gaze boundary for a period of time described in the present disclosure are heavily simplified. One skilled in the art will appreciate that the neural networks utilized may have significantly large datasets with highly specific details. The analysis would be beyond the capabilities of the human mind because the amount of data to be identified and processed within the span of an image or short video clip is unfathomable. In addition, each short video clip may have dozens of minute movements of facial key points to be distinguished and identified.

FIG. 2 is a diagram 200 illustrating an approach of training a machine learning model (MLM) to perform proctoring online examinations according to aspects of the present disclosure. In diagram 200, the machine learning module 108 includes at least a detection module 110 including a head pose estimation module 111a, an eye gaze estimation module 111b, and an comparison module 111c, one or more prepared neural networks 201, and a training module 112.

In some aspects, the head pose estimation module 111a will be configured to determine the position and orientation of the user's head in 3D space. At a high level, the process may include extracting key facial landmarks (e.g., nose, eyes, mouth, and jawline) using a neural network trained 201 for facial feature detection, using these landmarks to calculate the 3D position of the head relative to the camera using techniques such as Perspective-n-Point (PnP) or other similar algorithms, and outputs a head pose in terms of rotation (pitch, yaw, roll) and translation (x, y, z) coordinates.

In some aspects, the eye gaze estimation module 111b will be configured to estimate the user's eye direction or gaze vector relative to the head position. At a high level, the process may include: detecting eye regions from the image or head post output, mapping the detected eye features (e.g., pupil center, iris boundary) into a gaze direction vector using a neural network trained 201 on eye movement data, and output the gaze vector as a 3D vector (originating from the eye center) that shows where the user is looking relative to their head.

In some aspects, the comparison module 111c will be configured to combine head pose and gaze vector data to determine if the gaze is within or outside a predefined boundary. At a high level, the process may include: merging the head pose (origin of the gaze) and eye gaze vector to calculate the final 3D gaze origin and vector relative to a world or screen coordinate system; checking whether the extrapolated gaze vector intersects with or remains inside of ap redefined boundary represented as a geometric shape (e.g., a cuboid, sphere, or plane) in the 3D space; and determining whether the gaze vector intersects or lies within the boundary.

In some aspects, the one or more prepared neural networks corresponds to at least one of a gaze estimator, and a neural network that detects 3D facial key points and returns a 3D origin and vector of the gaze. In some aspects, the one or more prepared neural networks 201 are configured to handle: facial landmark detection for head pose estimation, eye region analysis and gaze direction calculation, and integration/inference optimization to process head pose and gaze vectors in real-time.

The training module 112 is configured to train the one or more prepared neural networks 201 using datasets with labeled 3D gaze data to accurately model variations in head movement, eye shapes, lighting, and camera angles. As mentioned above in FIG. 1, in some aspects, training of the neural networks to determine whether the gaze of the user is within the defined boundary may include training the neural network to detect the gaze of the user using a training dataset comprising of facial images of people gazing in different directions and a corresponding gaze origin and direction label for each image. In some aspects, training the neural network to detect the gaze of the user using a training dataset comprising of images of facial components comprising at least eyeballs, iris, or pupils to compute a gaze origin and vector in a post-processing step. In some aspects, the training dataset may be obtained from the training database 120.

FIGS. 3A-G is an example process flow of performing a calibration process to calibrate a field of view of a user according to aspects of the present disclosure. In various implementations, the process flow is performed by a device with one or more processors and non-transitory memory that performs intent prediction. In some implementations, the process is performed by processing logic, including hardware, firmware, software, or a combination thereof. In some implementations, the process flow is performed by a processor executing code stored in a non-transitory computer-readable medium (e.g., a memory). In order to proctor a user during an online examination, the 3D position of the computer screen should be determined according to a user-specific calibration process for each user taking the online examination.

The calibration process specific to a particular user is essential for detecting their gaze in 3D coordinates with a prepared neural network (e.g., the one or more prepared neural networks 201) due to significant variations in individual anatomy, behavior, test taking environment, and webcam. For example, the relationship between the user's eyes and the tracking hardware (e.g., webcam, camera, or sensor) varies based on a particular user's setup. As another example, the accuracy of determining whether the gaze is inside or outside the boundary relies on the precise calculation of gaze origin (e.g., eye position) and gaze vector direction. User-specific calibration ensures that the gaze boundary classification is robust and reliable, avoiding false positives or negatives due to individual differences. Furthermore, users are less likely to encounter errors (e.g., misinterpreted gaze inputs) when the system is calibrated to their specific test taking environment,.

These factors directly affect the accuracy of gaze origin and vector calculations, which are critical for determining whether the gaze is within the defined boundary. For example, unique gaze origin calibration identifies the precise spatial position of a user's eyes relative to the detection system. In addition, user-specific gave vector fine-tunes the mapping of the user's eye movements into 3D vectors, ensuring that their gaze direction aligns with real-world coordinates. Without user-specific calibration, the prepared neural network might misinterpret gaze data, leading to errors in determining whether the gaze intersects the defined boundary. Determining whether a gaze is within or outside a defined boundary simplifies decision-making tasks. For instance: if the gaze falls within the boundary, then the user is exhibiting normal test taking behavior. If the gaze is outside, then the user may be exhibiting suspicious or irregular test taking behavior. For example, the user may be cheating by looking at the monitor of another user or consulting unauthorized material that is located outside of the view of the display screen.

In example 300a of FIG. 3A, the computing device 101 begins a calibration process for a user 105 before the user 105 takes an online examination on the computing device 101. In some aspects, a display on the computing device 101 will display a message that instructs a user to move to a first position. The first position is approximately at one side of the display. In some aspects, the first position may be a predefined distance from the webcam.

In example 300b of FIG. 3B, after the user 105 moves to the first position, the display of the computing device 101 will display a first number in a first point of the display. As shown in example 300b, the first point is in the bottom right corner of the display. The computing device 101 may display a command to the user 105 to please enter the number displayed in the bottom right corner. For calibration purposes, the user 105 is asked to look at two or more points of the display. In addition, to make sure that the user 105 is looking at one of the two or more points, the computing device 101 will ask the user to enter the first number displayed at the first point of the display in order to confirm that the user 105 is looking at the first point of the display. Based on a determination that the user 105 has correctly identified the first number on the display, obtaining a first image of the user 105 gazing at the first point of the display when the user is in the first position. The first image captures a picture of the gaze of the user 105 and detect where the user 105 is looking.

In example 300c of FIG. 3C, while the user 105 is still in the first position, the display of the computing device 101 will display a second number in a second point of the display. As shown in example 300c, the second point is in the top left corner of the display. However, it should be noted that the second point may be in a different area of the display as long as the second point is at a point furthest away from the first point on the display. Based on a determination that the user 105 has correctly identified the second number on the display, obtaining a second image of the user 105 gazing at the second point of the display when the user is in the first position.

In example 300d of FIG. 3D, the display on the computing device 101 may display a message to instruct the user to move to a second position. In some aspect, the second position is shifted laterally along an axis (e.g., horizontally) with respect to the first position.

In example 300e of FIG. 3E, after the user 105 has moved in the second position, the display of the computing device 101 may display a third number in the first position of the display. Based on a determination that the user has correctly identified the third number on the display, obtain a third image of the user gazing at the first point of the display when the user is in the second position.

In example 300f of FIG. 3F, while the user 105 is in the second position, the display of the computing device 101 may display a fourth number (e.g., 11) in the second position of the display. Based on a determination that the user has correctly identified the fourth number on the display, obtain a fourth image of the user gazing the second point of the display when the user is in the second position.

In example 300g of FIG. 3G, the system may define the gaze boundary for the user by obtaining 3D vector coordinates for each gaze of the user in the first position and the second position by using triangulation or parallax and the first, second, third, and fourth images. The gaze boundary is crucial in gaze detection using 3D coordinates for several reasons-especially, when employing a prepared neural network to determine whether the gaze origin and vector are inside or outside the gaze boundary.

The gaze boundary provides a clear definition of the area of interest within which the user's gaze is relevant for the task. For instance, it can define the screen area. Without a boundary, it would be impossible to distinguish between gaze points concerning normal test-taking behavior (e.g., points of interest) from irregular or suspicious behavior (e.g., gazing away from the screen or object). In addition, neural networks often require a clearly defined input space for training and inference. A gaze boundary helps normalize data, ensuring the neural network learns to focus on patterns within the meaningful range of gaze vectors and origins. Accordingly, if the 3D gaze vector of the user 105 does not intersect with a screen plane 303 (e.g., the user 105 is looking outside the gaze boundary) in 3D world coordinates, a warning is displayed to the user 105 and the user 105 is suspected to be cheating.

As shown in example 300h of FIG. 3H, in some aspects, the screen plane 303 may not be restricted to the entire screen such that special shapes can be defined. For example, the screen plane 305 may be defined as a line between the two points to define a border that the gaze is not allowed to cross.

As shown in example 300i of FIG. 3I, in some aspects, the screen plane 303 (e.g., allowed area) can also be four points shaping a window 307 on a screen such that the user is not allowed to look away from the window 307.

User-specific calibration is critical for accurate and reliable 3D gaze detection. By accounting for individual anatomy, behavior, and environmental factors, calibration ensures that the neural network can accurately interpret the user's gaze origin and vector. This user-specific calibration process is essential for determining whether the gaze lies within a defined boundary and for providing a seamless and personalized user experience.

Although FIGS. 3A-I describes using two points of the display for calibration, it should be noted that there may be four points of the display (e.g., one point at each corner of the display) used for calibration.

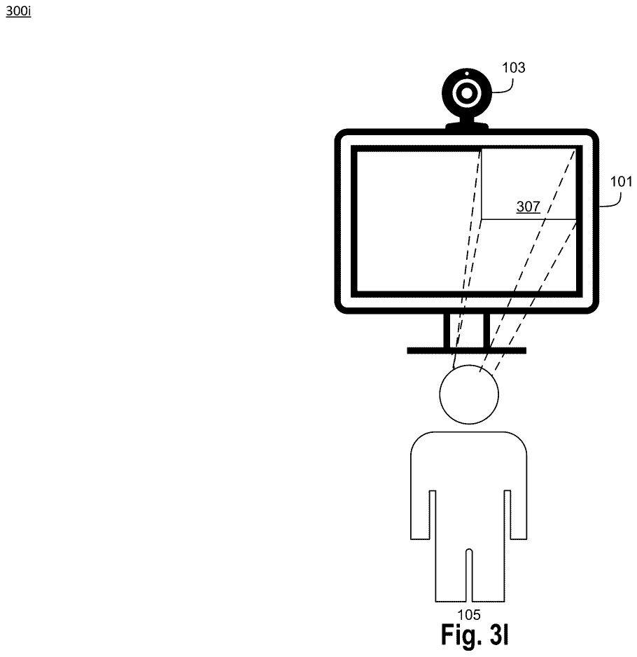

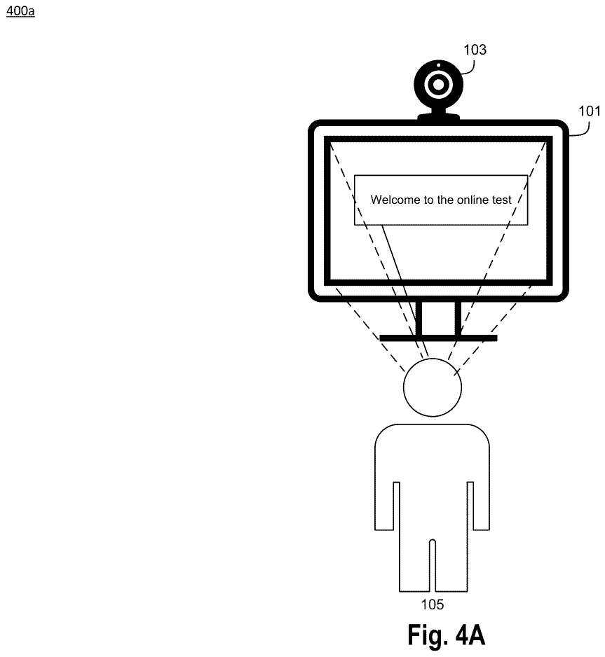

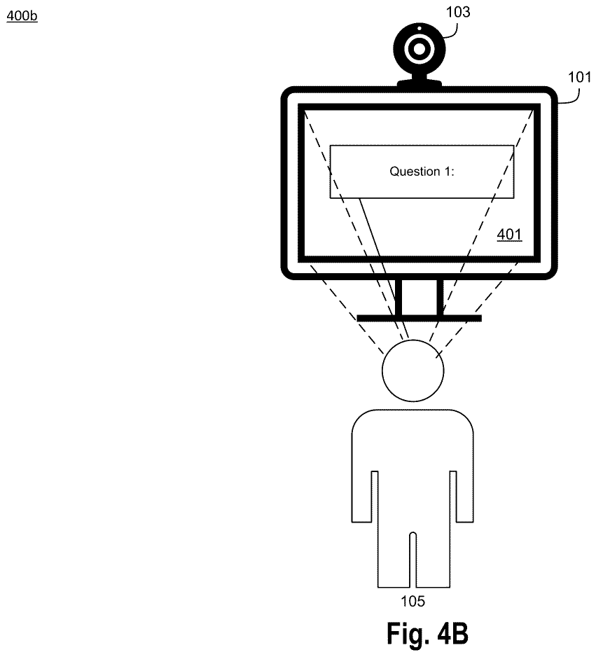

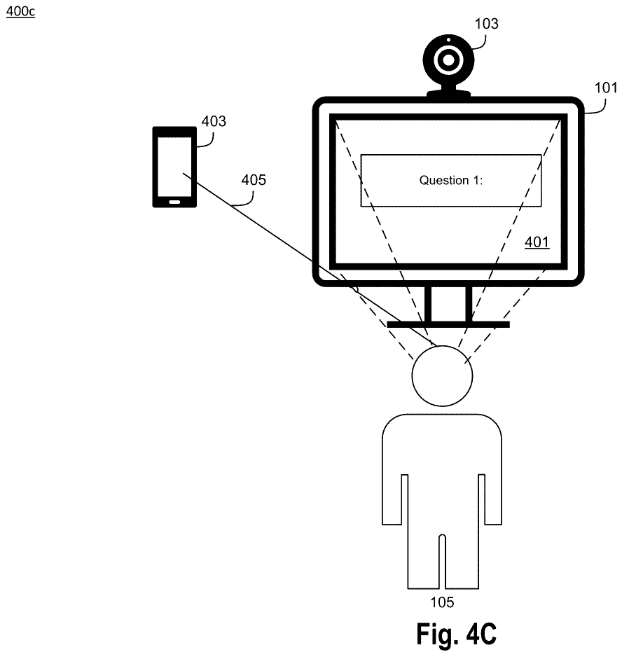

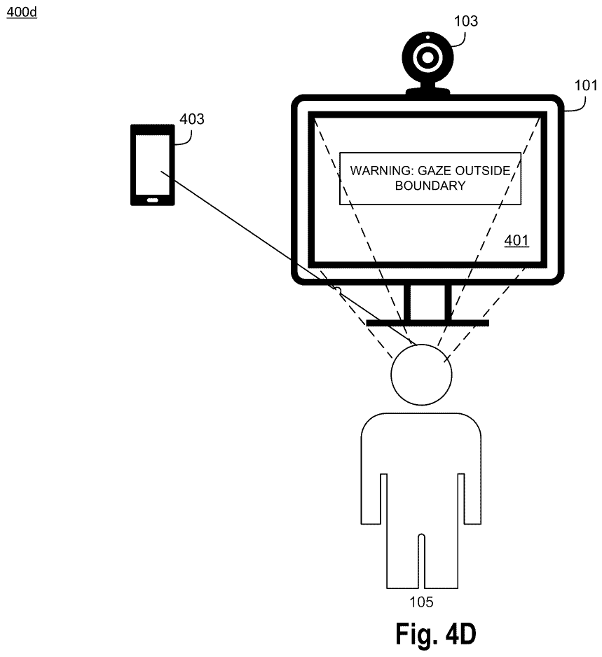

FIGS. 4A-D is an example process flow of performing a gaze detection method for the user taking the online examination according to aspects of the present disclosure. In various implementations, the process flow is performed by a device with one or more processors and non-transitory memory that performs intent prediction. In some implementations, the process is performed by processing logic, including hardware, firmware, software, or a combination thereof. In some implementations, the process flow is performed by a processor executing code stored in a non-transitory computer-readable medium (e.g., a memory).

After the calibration process, the user is observed by a webcam 103 during the entire examination. One or more prepared neural networks from the detection module 110 or machine learning module 108 continuously detects the gaze vector of the user 105 during the examination. Accordingly, if the user 105 looks away from the display for the computing device 101 for a period of time, then the one or more prepared neural networks from the detection module 110 or machine learning module 108 will detect this.

In example 400a of FIG. 4A, the user 105 has completed a calibration process and is ready to take the online examination on the computing device 101. The webcam 103 will record the user 105 while the user 105 is taking the examination.

In example 400b of FIG. 4B, the computing device 101 will begin to administer the online examination to the user 105. As shown in example 400b, the user is exhibiting normal test taking behavior because the gaze vector of the user 105 intersects with the display 401 in 3D world coordinates.

In example 400c of FIG. 3C, the user is attempting to cheat by looking at a device 403 that is outside of the view of the webcam 103. The device 403 may contain notes or other unauthorized test material used by the user 105 to cheat on the online examination. In this case, the user 105 is looking away from the display of the computing device 101 such that the gaze vector 405 of the user 105 does not intersect with the display 401 in 3-D world coordinates.

In example 400d of FIG. 3D, since it is determined that user 105 has looked away from the display of the computing device 101 then the user 105 may be suspected of cheating and a warning is displayed on the display of the computing device 101.

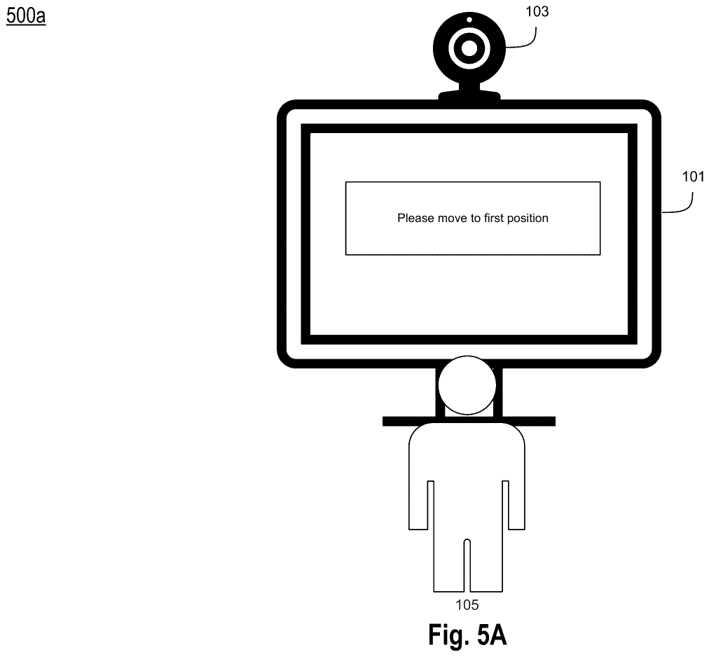

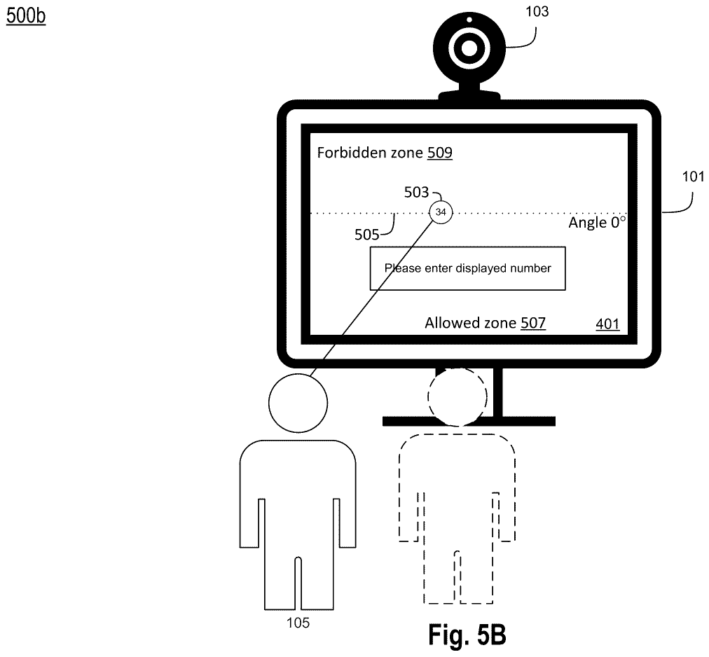

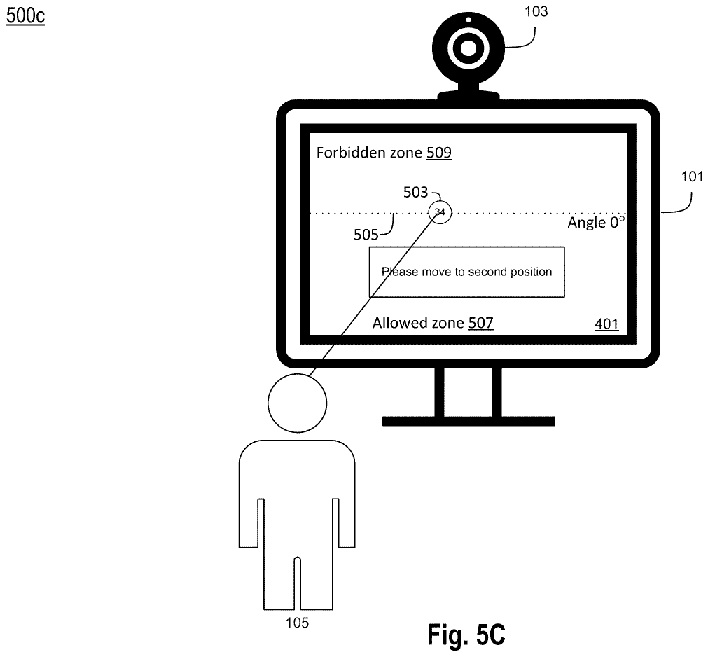

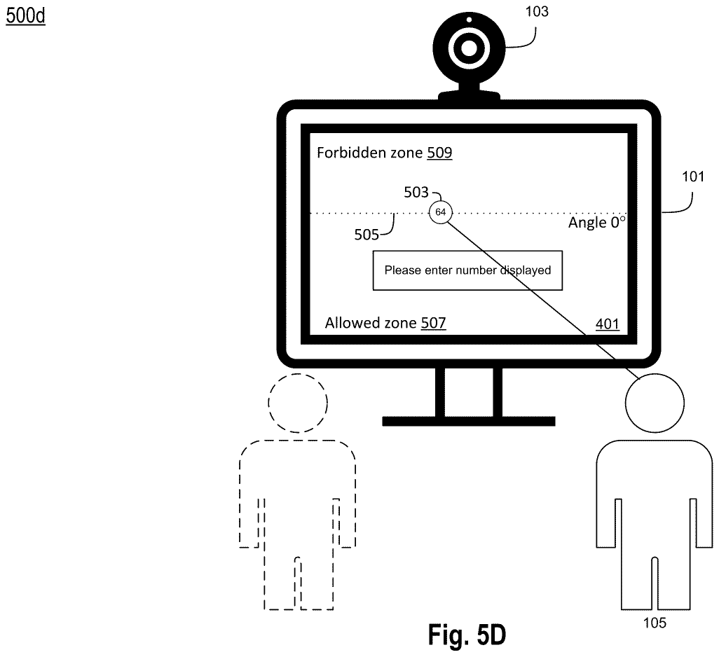

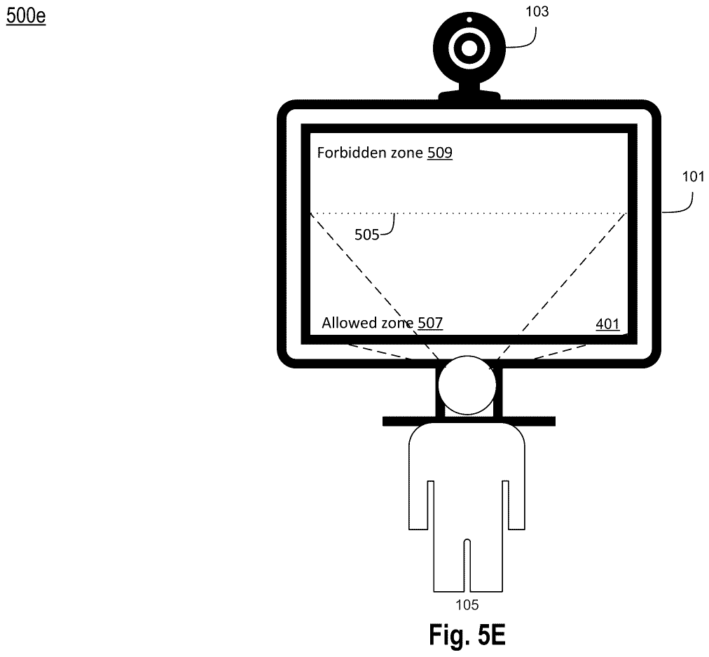

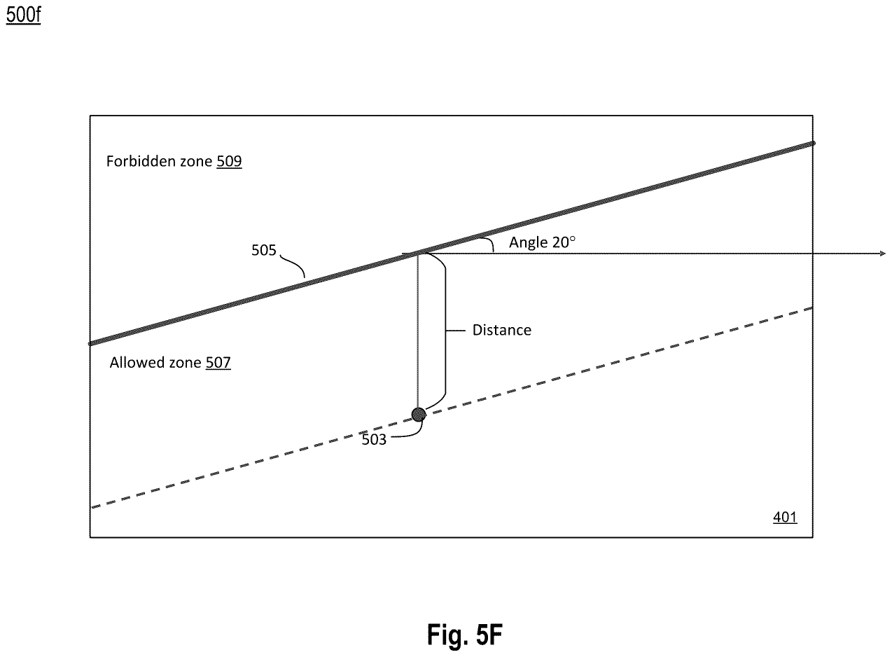

FIGS. 5A-5F is an example process flow of performing a calibration process to calibrate a field of a user using a single point based on a virtual border according to aspects of the present disclosure. The examples shown in FIGS. 5A-5F differ from FIG. 3A-3I because the examples in FIG. 5A-5F describe a calibration process using a single point rather than a calibration process using four points as depicted in FIG. 3A-3I. In various implementations, the process flow is performed by a device with one or more processors and non-transitory memory that performs intent prediction. In some implementations, the process is performed by processing logic, including hardware, firmware, software, or a combination thereof. In some implementations, the process flow is performed by a processor executing code stored in a non-transitory computer-readable medium (e.g., a memory). In order to perform identify verification of a user during an online session, the 3D position of the computer screen should be determined according to a user-specific calibration process for each user.

In example 500a of FIG. 5A, the computing device begins a calibration process for a user 105 before the user begins an online session that requires a real-time identify verification process on the computing device 101. In some aspects, a display 401 on the computing device 101 will display a message that instructs a user to move to a first position. In some aspects, the first position is approximately at one side of the display. In some aspects, the first position may be a predefined distance from the webcam 103.

In example 500b of FIG. 5B, after the user 105 moves to the first position, the display of the computing device 101 will display a first number in a single point 503 of the display. As shown in example 300b, the first point is in the bottom right corner of the display. The computing device 101 may display a command to the user 105 to please enter the number (e.g., 34) displayed in the bottom right corner. For calibration purposes and to make sure that the user 105 is looking at the single point 503, the computing device 101 will ask the user to enter the number displayed at the single point of the display 401 in order to confirm that the user 105 is looking at the single point of the display. The single point 503 is positioned directly on the virtual border 505 at a predefined angle of 0 degrees (e.g., horizontal virtual border) relative to the X axis and a predefined distance (e.g., 0) away from the single point 503 on the display 401. The virtual border 505 further demarcates the display 401 into a forbidden zone 509 and an allowed zone 507 such that an alert will be generated if the user 105 is determined to be gazing in the forbidden zone 509 past a predefined time threshold.

Based on a determination that the user 105 has correctly identified the number on the display 401, obtaining a first image of the user 105 gazing at the single point 503 of the display 401 when the user 105 is in the first position. The first image captures a picture of the gaze of the user 105 and detect where the user 105 is looking.

In example 500c of FIG. 5C, the display on the computing device 101 may display a message to instruct the user 105 to move to a second position. In some aspect, the second position is shifted laterally along an axis (e.g., horizontally) with respect to the first position.

In example 500d of FIG. 5D, after the user 105 has moved in the second position, the display of the computing device 101 may display a second number (e.g., 64) in the single point 503 of the display. Based on a determination that the user 105 has correctly identified the second number on the display 401, obtain a second image of the user 105 gazing at the single point 503 of the display 401 when the user is in the second position.

In example 500e of FIG. 5E, the system may define the gaze boundary for the user 105 into an allowed zone 507 by obtaining 3D vector coordinates for each gaze of the user 105 in the first position and the second position by using triangulation or parallax and the first and second images.

As shown in FIG. 5F, example 500f shows a single point 503 on the display 401 with a virtual border 505 at a predefined angle of 20 degrees relative to the X axis and a predefined distance away from the single point 503. The virtual border 505 further demarcates the display 401 into a forbidden zone 509 and an allowed zone 507 such that an alert will be generated if the user gazes in the forbidden zone 509 past a predefined time threshold.

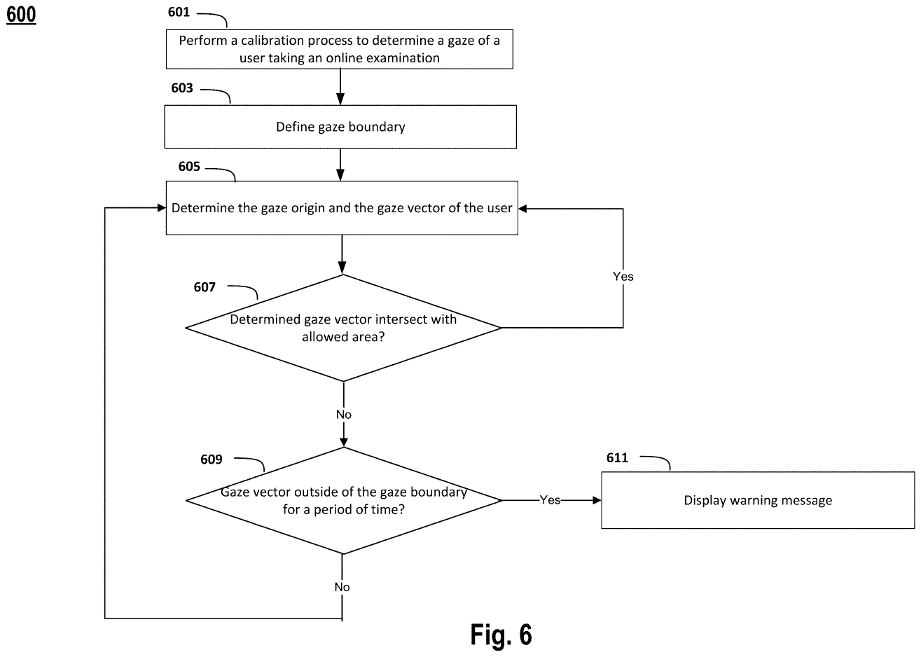

FIG. 6 is a flow diagram of a method performing a gaze determination method according to aspects of the present disclosure. In various implementations, the process flow is performed by a device with one or more processors and non-transitory memory that performs intent prediction. In some implementations, the method 600 is performed by processing logic, including hardware, firmware, software, or a combination thereof. In some implementations, the process flow is performed by a processor executing code stored in a non-transitory computer-readable medium (e.g., a memory). The method 600 describes a method of performing gaze detection to proctor users taking an online examination.

At 601, the method 600 may include performing a calibration process to calibrate a field of view of a user taking an online examination on a computer. As an example, referring back to FIG. 1, the calibration module 104 may be configured to calibrate a field of view of a user taking an online examination on a computer.

In some aspects, the method 600 may include displaying a first number in a single point of a display when the user is in a first position, wherein the single point is a predefined distance away from a virtual border along a y axis or a x axis and the virtual border is generated at a predefined angle from the y axis or the x axis such that the virtual border demarcates the display into an allowed zone and a forbidden zone; based on a determination that the user has correctly identified the first number on the display, obtaining a first image of the user gazing at the single point of the display when the user is in the first position; displaying a second number in the single point of the display when the user is in a second position; based on a determination that the user has correctly identified the second number on the display, obtaining a second image of the user gazing at the single point of the display when the user is in the second position, wherein the defined boundary for the user is further defined using the forbidden zone based on the virtual border and by obtaining 3D vector coordinates for the gaze of the user by using triangulation or parallax and the first image and second image. In some aspects, the predefined distance away from the virtual border may be 0.

The defined boundary for the user is further defined using the forbidden zone based on the virtual border and by obtaining 3D vector coordinates for the gaze of the user by using triangulation or parallax and the first image and the second image. As an example, referring back to FIG. 5A, example 500a shows a single point 503 on the display 401 with a virtual border 505 at a predefined angle of 0 degrees (e.g., horizontal virtual border) relative to the X axis and a predefined distance away from the single point on the display. As another example, referring back to FIG. 5B, example 500b shows a single point 503 on the display 401 with a virtual border 505 at a predefined angle of 20 degrees relative to the X axis and a predefined distance away from the single point 503.

In some aspects, the second position is shifted laterally along an axis with respect to the first position.

In some aspects, the method 600 may include: displaying a first number in a first point of a display when the user is in a first position, wherein the first point is along a first boundary of a display; based on a determination that the user has correctly identified the first number on the display, obtaining a first image of the user gazing at the first point of the display when the user is in the first position; displaying a second number in a second point of the display when the user is in the first position; based on a determination that the user has correctly identified the second number on the display, obtaining a second image of the user gazing at the second point of the display when the user is in the first position; displaying a third number in a first point of the display when the user is in a second position; based on a determination that the user has correctly identified the third number on the display, obtaining a third image of the user gazing at the first point of the display when the user is in the second position; displaying a fourth number in the second point of the display when the user is in the second position; based on a determination that the user has correctly identified the fourth number on the display, obtaining a fourth image of the user gazing the second point of the display when the user is in the second position, wherein the defined boundary for the user is defined by obtaining 3D vector coordinates for each gaze of the user in the first position and the second position by using triangulation or parallax and the first, second, third, and fourth images. As an example, referring back to FIGS. 3A-3G, the method may include displaying a first number (e.g., 34) at the bottom right corner of the display and displaying a second number (e.g., 12) at the top right corner of the display while the user is in the first position and displaying a third number (e.g., 23) at the bottom right corner of the display and displaying a fourth number (e.g., 11) at the top right corner of the display while the user is in the second position.

In some aspects, the second position is shifted laterally along an axis with respect to the first position.

In some aspects, performing the calibration process further comprises: when the user is in a first position, display a first number, a second number, a third number, a fourth number in a first corner, a second corner, a third corner, and a fourth corner of a display, respectively; based on a determination that the user has correctly identified the first number, the second number, the third number, and the fourth number on the display, obtaining a respective image of the user gazing at each of the first corner, the second corner, the third corner, and the fourth corner of the display when the user is in the first position; when the user is in a second position, display a fifth number, a sixth number, a seventh number, an eighth number in the first corner, the second corner, the third corner, and the fourth corner of a display, respectively; based on a determination that the user has correctly identified the fifth number, the sixth number, the seventh number, and the eighth number on the display, obtaining a respective image of the user gazing at each of the first corner, the second corner, the third corner, and the fourth corner of the display when the user is in the second position, wherein the defined boundary is defined for the user by obtaining 3D origin and vector coordinates for each gaze of the user in the first position and the second position by using triangulation or parallax and the obtained images of the user gazing at each of the first corner, the second corner, the third corner, and the fourth corner when the user is in the first position and the second position.

At 603, the method 600 may include defining a gaze boundary based on a gaze origin and gaze vector of the user. In some aspects, defining the gaze boundary based on the gaze origin and gaze vector of the user may be performed by a prepared neural network.

At step 605, the method 600 may include determining whether the gaze vector of the user is within the defined boundary relative to the gaze origin for determining, by a webcam or camera, a gaze of the user in three-dimensional (3D) coordinates. In some aspects, determining the gaze of the user in 3D coordinates to determine whether the gaze vector of the user is within a defined boundary relative to the gaze origin further comprises computing the gaze vector in a post-processing step.

At step 607, the method 600 may include determining if the determined gaze vector intersects with an allowed polygon and/or area. Based on a determination that the determined gaze intersects with the allowed polygon and/or area, then the method 600 continues back to 605. Based on a determination that the determined gaze does not intersect with the allowed polygon and/or area, then, at 609, the method 600 may include determining whether a gaze vector of the user is outside of the gaze boundary for a period of time.

In some aspects, the method 600 may include determining the gaze origin and the gaze vector of the user in each image using a prepared neural network to obtain facial key points of the user. In some aspects, the facial key points of a user may correspond to specific locations on the face of the user such as at least one of: eyes (e.g., corners of the eyes, centers of the pupils, or eyelid outlines), eyebrows (e.g., outer and inner edges as well as several intermediate points), nose (e.g., tip of the nose, nostrils, and bridge points), mouth (e.g., corners of the mouth, center points of the upper and lower lips, and contours of the lips), jawline (e.g., chin and several points along the jawline), ears (e.g., points on the outer edges of the ears), or facial outline (e.g., contour points along the face, from the forehead to the chin).

In some aspects, the number of facial key points may vary depending on the application. For example, a basic system may use fewer points (e.g., 5-10 points for simple face detection) or an advanced system may use detailed models like a 68-point or 98-point system for tasks like 3D modeling or fine-grained expression analysis.

In some aspects, the prepared neural network corresponds to at least one of: a gaze estimator, and a neural network that detects 3D facial key points and returns a 3D origin and vector of the gaze. In some examples, the neural network may correspond to a network that processes an image and detects 3D facial key points including at least the iris and returns a 3D vector of the gazing direction with origins: x, y, z, dx, dy, dz. In this case, x, y, and z represent the starting position or coordinates of points in 3D space such that x corresponds to the coordinate along the horizontal axis, y corresponds to the coordinate along the vertical axis, and y corresponds to the coordinate along the depth axis (e.g., into or out of the screen in a typical 3D system) and dx, dy, and dz represent the components of a direction vector that extends from the origin (x, y, z) such that dx corresponds to the change in the x-direction, dy corresponds to the change in the y-direction, and dz corresponds to the change in the z-direction. In other words, the direction vector indicates where the point or object is “pointing” or “moving” relative to its origin.

In some aspects, the method 600 may comprise: preparing the neural network to determine whether the gaze of the user is within the defined boundary by training the neural network to detect the gaze of the user using a training dataset comprising of facial images of people gazing in different directions and a corresponding gaze origin and direction label for each image. As an example, referring back to FIG. 1, the training module 112 may be configured to prepare the neural network to determine whether the gaze of the user is within the defined boundary by training the neural network to detect the gaze of the user using a training dataset obtained from the training database 120.

In some aspects, the method 600 may comprise preparing of the neural network to determine whether the gaze of the user is within the defined boundary by training the neural network to detect the gaze of the user using a training dataset comprising of images of facial key points comprising at least eyeballs, iris, or pupils to compute a gaze origin and vector in a post-processing step. As an example, referring back to FIG. 1, the training module 112 may be configured to prepare the neural network to determine whether the gaze of the user is within the defined boundary by training the neural network to detect the gaze of the user using a training dataset comprising of images of facial key points comprising at least eyeballs, iris, or pupils to compute a gaze origin and vector in a post-processing step.

Based on a determination that the gaze vector is outside of the gaze boundary for a period of time, then, at 611, the method 600 includes displaying a warning message. As an example, referring back to FIG. 4D, the display of the computing device 101 may be configured to display a warning that gaze is outside boundary after determining that the gaze vector of the user 105.

Based on a determination that the gaze vector is not outside of the gaze boundary for the period of time, then, at 605, the method 600 continues to determine the gaze origin and gaze vector of the user.

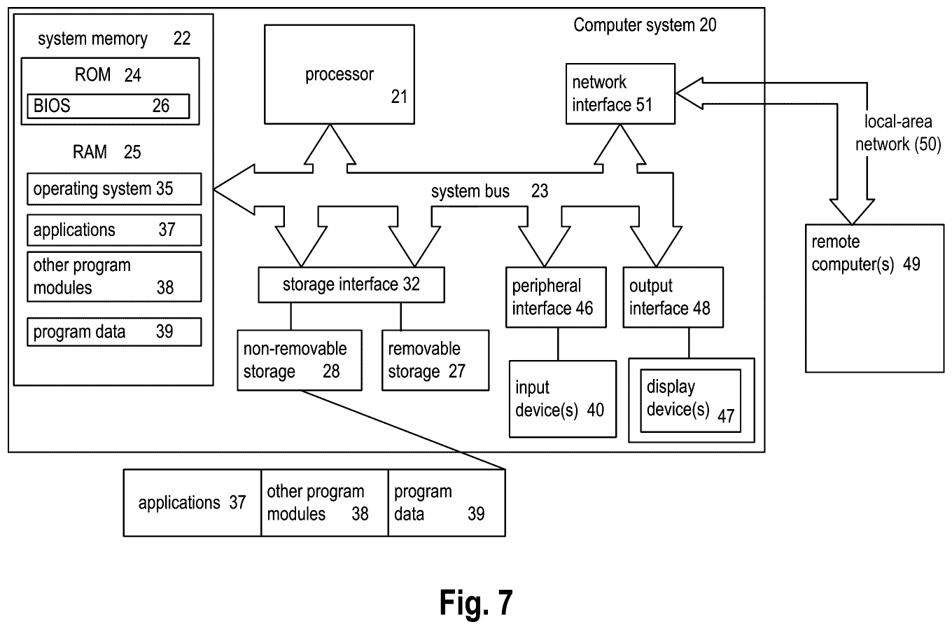

FIG. 7 is a block diagram illustrating a computer system 20 on which aspects of systems and methods for proctoring online examinations may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of proctoring online examinations, comprising:
performing a calibration process to calibrate a field of view of a user taking an online examination on a computer;
after the calibration process is completed, obtain facial key points of the user for determining a gaze origin and a gaze vector of the user using a prepared neural network and determining, by a webcam or camera, a gaze of the user in three-dimensional (3D) coordinates to determine whether the gaze vector of the user is within a defined boundary relative to the gaze origin; and
based on a determination that the gaze vector of the user is outside the defined boundary for a period of time, transmitting a message that the gaze of the user is outside of the defined boundary.

2. The method of claim 1, wherein performing the calibration process further comprises:
displaying a first number in a single point of a display when the user is in a first position, wherein the single point is a predefined distance away from a virtual border along a y axis or a x axis and the virtual border is generated at a predefined angle from the y axis or the x axis such that the virtual border demarcates the display into an allowed zone and a forbidden zone;
based on a determination that the user has correctly identified the first number on the display, obtaining a first image of the user gazing at the single point of the display when the user is in the first position;
displaying a second number in the single point of the display when the user is in a second position; and
based on a determination that the user has correctly identified the second number on the display, obtaining a second image of the user gazing at the single point of the display when the user is in the second position, wherein the defined boundary for the user is further defined using the forbidden zone based on the virtual border and by obtaining 3D vector coordinates for the gaze of the user by using triangulation or parallax and the first image and the second image.

3. The method of claim 2, wherein the second position is shifted laterally along an axis with respect to the first position.

4. The method of claim 1, wherein performing the calibration process further comprises:
displaying a first number in a first point of a display when the user is in a first position, wherein the first point is along a first boundary of the display;
based on a determination that the user has correctly identified the first number on the display, obtaining a first image of the user gazing at the first point of the display when the user is in the first position;
displaying a second number in a second point of the display when the user is in the first position;
based on a determination that the user has correctly identified the second number on the display, obtaining a second image of the user gazing at the second point of the display when the user is in the first position;
displaying a third number in the first point of the display when the user is in a second position;
based on a determination that the user has correctly identified the third number on the display, obtaining a third image of the user gazing at the first point of the display when the user is in the second position;
displaying a fourth number in the second point of the display when the user is in the second position; and
based on a determination that the user has correctly identified the fourth number on the display, obtaining a fourth image of the user gazing the second point of the display when the user is in the second position, wherein the defined boundary for the user is defined by obtaining 3D vector coordinates for each gaze of the user in the first position and the second position by using triangulation or parallax and the first, second, third, and fourth images.

5. The method of claim 4, wherein the second position is shifted laterally along an axis with respect to the first position.

6. The method of claim 1, wherein performing the calibration process further comprises:
when the user is in a first position, display a first number, a second number, a third number, a fourth number in a first corner, a second corner, a third corner, and a fourth corner of a display, respectively;
based on a determination that the user has correctly identified the first number, the second number, the third number, and the fourth number on the display, obtaining a respective image of the user gazing at each of the first corner, the second corner, the third corner, and the fourth corner of the display when the user is in the first position;
when the user is in a second position, display a fifth number, a sixth number, a seventh number, an eighth number in the first corner, the second corner, the third corner, and the fourth corner of the display, respectively; and
based on a determination that the user has correctly identified the fifth number, the sixth number, the seventh number, and the eighth number on the display, obtaining a respective image of the user gazing at each of the first corner, the second corner, the third corner, and the fourth corner of the display when the user is in the second position, wherein the defined boundary is defined for the user by obtaining 3D origin and vector coordinates for each gaze of the user in the first position and the second position by using triangulation or parallax and the obtained images of the user gazing at each of the first corner, the second corner, the third corner, and the fourth corner when the user is in the first position and the second position.

7. The method of claim 6, wherein the second position is shifted laterally along an axis with respect to the first position.

8. The method of claim 1, wherein the prepared neural network corresponds to at least one of: a gaze estimator, and a neural network that detects 3D facial key points and returns a 3D origin and vector of the gaze.

9. The method of claim 1, further comprising:
preparing the neural network to determine whether the gaze of the user is within the defined boundary by training the neural network to detect the gaze of the user using a training dataset comprising of facial images of people gazing at different directions and a corresponding gaze origin and direction label for each image.

10. The method of claim 1, further comprising:
preparing of the neural network to determine whether the gaze of the user is within the defined boundary by training the neural network to detect the gaze of the user using a training dataset comprising of images of facial key points comprising at least eyeballs, iris, or pupils to compute a gaze origin and vector.

11. The method of claim 1, wherein determining the gaze of the user in 3D coordinates to determine whether the gaze vector of the user is within a defined boundary relative to the gaze origin further comprises computing the gaze vector.

12. A system of proctoring online examinations, comprising:
at least one memory; and
at least one hardware processor coupled with the at least one memory and configured, individually or in combination, to:
perform a calibration process to calibrate a field of view of a user taking an online examination on a computer;
after the calibration process is completed, obtain facial key points of the user for determining a gaze origin and a gaze vector of the user using a prepared neural network and determining, by a webcam or camera, a gaze of the user in three-dimensional (3D) coordinates to determine whether the gaze vector of the user is within a defined boundary relative to the gaze origin; and
based on a determination that the gaze vector of the user is outside the defined boundary for a period of time, transmit a message that the gaze of the user is outside of the defined boundary.

13. The system of claim 12, wherein the at least one hardware processor is coupled with the at least one memory and configured, individually or in combination, to:
displaying a first number in a single point of a display when the user is in a first position, wherein the single point is a predefined distance away from a virtual border along a y axis or a x axis and the virtual border is generated at a predefined angle from the y axis or the x axis such that the virtual border demarcates the display into an allowed zone and a forbidden zone;
based on a determination that the user has correctly identified the first number on the display, obtaining a first image of the user gazing at the single point of the display when the user is in the first position;
displaying a second number in the first point of the display when the user is in a second position; and
based on a determination that the user has correctly identified the second number on the display, obtaining a second image of the user gazing at the first point of the display when the user is in the second position, wherein the defined boundary for the user is further defined using the forbidden zone based on the virtual border and by obtaining 3D vector coordinates for the gaze of the user by using triangulation or parallax and the first image and the second image.

14. The system of claim 13, wherein the second position is shifted laterally along an axis with respect to the first position.

15. The system of claim 12, wherein the at least one hardware processor is coupled with the at least one memory and configured, individually or in combination, to:
displaying a first number in a first point of a display when the user is in a first position, wherein the first point is along a first boundary of the display;
based on a determination that the user has correctly identified the first number on the display, obtaining a first image of the user gazing at the first point of the display when the user is in the first position;
display a second number in a second point of the display when the user is in the first position;
based on a determination that the user has correctly identified the second number on the display, obtain a second image of the user gazing at the second point of the display when the user is in the first position;
display a third number in the first point of the display when the user is in a second position;
based on a determination that the user has correctly identified the third number on the display, obtain a third image of the user gazing at the first point of the display when the user is in the second position;
display a fourth number in the second point of the display when the user is in the second position; and
based on a determination that the user has correctly identified the fourth number on the display, obtain a fourth image of the user gazing the second point of the display when the user is in the second position, wherein the defined boundary for the user is defined by obtaining 3D vector coordinates for each gaze of the user in the first position and the second position by using triangulation or parallax and the first, second, third, and fourth images.

16. The system of claim 15, wherein the second position is shifted laterally along an axis with respect to the first position.

17. The system of claim 12, wherein performing the calibration further comprises:
when the user is in a first position, display a first number, a second number, a third number, a fourth number in a first corner, a second corner, a third corner, and a fourth corner of a display, respectively;
based on a determination that the user has correctly identified the first number, the second number, the third number, and the fourth number on the display, obtaining a respective image of the user gazing at each of the first corner, the second corner, the third corner, and the fourth corner of the display when the user is in the first position;
when the user is in a second position, display a fifth number, a sixth number, a seventh number, an eighth number in the first corner, the second corner, the third corner, and the fourth corner of the display, respectively; and
based on a determination that the user has correctly identified the fifth number, the sixth number, the seventh number, and the eighth number on the display, obtaining a respective image of the user gazing at each of the first corner, the second corner, the third corner, and the fourth corner of the display when the user is in the second position, wherein the defined boundary is defined for the user by obtaining 3D origin and vector coordinates for each gaze of the user in the first position and the second position by using triangulation or parallax and the obtained images of the user gazing at each of the first corner, the second corner, the third corner, and the fourth corner when the user is in the first position and the second position.

18. The system of claim 17, wherein the second position is shifted laterally along an axis with respect to the first position.

19. The system of claim 12, wherein the prepared neural network corresponds to at least one of: a gaze estimator, and a neural network that detects 3D facial key points and returns a 3D origin and vector of the gaze.

20. A non-transitory computer readable medium storing thereon computer executable instructions for proctoring online examinations, including instructions for:
performing a calibration process to calibrate a field of view of a user taking an online examination on a computer;
after the calibration process is completed, obtain facial key points of the user for determining a gaze origin and a gaze vector of the user using a prepared neural network and determining, by a webcam or camera, a gaze of the user in three-dimensional (3D) coordinates to determine whether the gaze vector of the user is within a defined boundary relative to the gaze origin; and
based on a determination that the gaze vector of the user is outside the defined boundary for a period of time, transmitting a message that the gaze of the user is outside of the defined boundary.
